(19) United States
(12) Patent Application Publication
(10) Pub. No.: US 2003/0184953 A1
(43) Pub. Date: Oct. 2, 2003

(54) Structure of an interleaving striped capacitor substrate

(76) Inventors: Min-Lin Lee, Hsinchu (TW); Chin-Sun Shyu, Pingtung (TW); Shur-Fen Liu, Hsinchu (TW); Jing-Pin Pan, Hsinchu (TW); Jinn-Shing King, Hsinchu (TW)

Correspondence Address: BIRCH STEWART KOLASCH & BIRCH, PO BOX 747, FALLS CHURCH, VA, 22040-0747, US

(21) Appl. No.: 10/378,603

(22) Filed: Mar. 5, 2003

(30) Foreign Application Priority Data
Mar. 29, 2002 (TW) 091203987

(51) Int. Cl. H01G 4/20

(52) U.S. Cl. 361/312

(57) ABSTRACT

An interleaving striped capacitor substrate structure for pressing-type print circuit boards are disclosed. To achieve the high-frequency, high-speed, and high-density trend in modern electronic systems, the interleaving striped capacitor substrate structure uses several dielectric materials of different dielectric coefficients to make a dielectric layer. According to the practical needs, one or both sides of the dielectric layer is adhered with a conductive metal layer to form a capacitor substrate so that a single capacitor substrate can provide the lower dielectric coefficient substrate required for high-speed signal transmissions and the high dielectric coefficient substrate required by the decoupling capacitor to suppress the high-frequency noise signals. This simultaneously achieves the effects of lowering the high-frequency transmission time and suppressing high-frequency noises.

### BACKGROUND OF THE INVENTION

1. Field of Invention

The invention relates to a capacitor substrate and, in particular, to the structure of an interleaving striped capacitor substrate.

2. Related Art

The print circuit board for supporting electronic elements in normal electronic systems is usually a planar substrate of a single low dielectric coefficient material (such as glass fiber cloths). Its drawbacks are that the low dielectric coefficient material has an inferior effect in suppressing high-frequency noises and the integrity of passive elements on the print circuit board is bad. It is not ideal for modern electronic systems where high frequencies, high speeds and compactness are the basic requirements. Consequently, the print circuit board needs to be improved for providing the abilities to suppress high-frequency noises, to enhance the integration of elements, and to reduce high-speed signal delays.

The U.S. Pat. No. 5,161,086 provides an improved print circuit board to suppress the high-frequency noise interference. In that patent, the upper and lower surfaces of a dielectric material layer are attached with a conductive metal layer to form a capacitor substrate. The capacitor substrate is stacked onto a print circuit board by pressing. Since each capacitor substrate has only one dielectric coefficient, if different capacitances are required (e.g. when one needs a low dielectric coefficient capacitor substrate for high-speed signal transmissions and a high dielectric coefficient capacitor substrate for the decoupling capacitor that suppresses high-frequency noises) one has to stack several capacitor substrates with different dielectric coefficients on the print circuit board.

In addition, the drawback of this method is that a single-layered capacitor substrate has only one dielectric coefficient that cannot simultaneously provide the capacitance properties required by a high-frequency and high-speed electronic system. In order to satisfy different electronic requirements, the cost of the print circuit board inevitably will increase due to stacking multiple layers of capacitor substrates. For the mixed high-frequency analog and high-speed digital systems, the integrity of the added passive elements is still inadequate.

### SUMMARY OF THE INVENTION

To improve the prior art and to satisfy the requirements of a high-frequency, high-speed and high-density electronic system, the invention provides a capacitor substrate imbedded with interleaving striped capacitors. The invention uses dielectric materials with different dielectric coefficients (the relative dielectric coefficient ∈ᵣ) to compose a capacitor substrate with striped capacitors. Therefore, a single piece of the capacitor substrate thus made can simultaneously provide the low dielectric coefficient (∈ᵣ≦4) required for high-speed signal transmissions and the high dielectric coefficient (∈ᵣ≧10) required by the decoupling capacitor that suppresses high-frequency noises. This helps increase the integrity of elements and the circuit density.

The disclosed interleaving striped capacitor substrate uses several dielectric materials with different dielectric coefficients on one plane to compose a striped capacitor substrate. According to practical needs, more than one layer of the disclosed striped capacitor substrate can be stacked on a multiple-layer print circuit board for wider applications. The structure of the invention includes: a dielectric layer formed using several dielectric materials and a conductive metal layer on the top and bottom surfaces of the dielectric layer. By forming the required conductive wire pattern on the top and bottom conductive metal layer, the capacitor substrate with different dielectric coefficients can be designed as a capacitor or a signal transmission line.

For different circuit designs, the invention has another structure which includes: a dielectric layer comprised of several dielectric materials and a conductive metal layer formed on the top surface of the dielectric layer. That is, the dielectric layer is only a capacitor substrate with a conductive metal layer on one surface. It can combine with the conductive layer on the print circuit board to form the desired capacitor. To summarize, the disclosed interleaving striped capacitor substrate can be attached with either a layer of conductive metal on one surface of the dielectric layer or a layer of conductive metal on both surfaces of the dielectric layer, forming a single-layered capacitor substrate. Several such single-layered capacitor substrates may be simultaneously used in any layer of a multiple-layered print circuit board, forming a multiple-layered capacitor substrate.

### BRIEF DESCRIPTION OF THE DRAWINGS

The invention will become more fully understood from the detailed description given hereinbelow illustration only, and thus are not limitative of the present invention, and wherein:

FIG. 1 is a schematic cross section of a triple-layered interleaving striped capacitor substrate of the invention;

FIG. 2 is an exploded view of a triple-layered interleaving striped capacitor substrate of the invention;

FIG. 3 is a schematic cross section of a single-layered interleaving striped capacitor substrate comprised of five dielectric materials;

FIG. 4 is a schematic cross section of the single-layered interleaving striped capacitor substrate comprised of five dielectric materials stacked onto a print circuit board; and

FIG. 5 is a schematic cross section of the multiple-layered capacitor substrate combined with an integrated circuit element.

### DETAILED DESCRIPTION OF THE INVENTION

The disclosed structure of an interleaving striped capacitor substrate utilizes dielectric materials of different dielectric coefficients (the relative dielectric coefficient ∈ᵣ) to make a striped capacitor substrate. Therefore, the single-layered capacitor substrate can simultaneously provide the low dielectric coefficient required for high-speed signal transmissions and the high dielectric coefficient required for the decoupling capacitor that suppresses high-frequency noises. Not only can the invention increase the transmission rate and suppress interference of high-frequency noises in an integrated electronic system, it can further reduce the number of layers on a substrate.

For different application ranges and for the capacitor substrate to be combined onto various circuit designs of print circuits, the invention provides two types of capacitor substrate structures. One contains a dielectric layer comprised of several interleaving striped dielectric materials. Each of the upper and lower surfaces of the dielectric layer is attached with a conductive metal layer to form a three-layered capacitor substrate. The upper- and lower-surface metal layers are etched to produce capacitors. The capacitance is controlled by adjusting the area of the upper- and lower-surface metal layers.

The other structure is a dielectric layer comprised of several interleaving striped dielectric materials. However, only one surface of the dielectric layer is attached with a first conductive metal layer to form a two-layered capacitor substrate. This structure is used to combine with a single-layered or multiple-layered circuit board to form a multiple-layered capacitor substrate embedded with interleaving striped capacitors. The surface of the print circuit board has a second conductive metal layer. The first conductive metal layer and the second conductive metal layer are etched to form several capacitors with the dielectric materials. The capacitance of each of the capacitors is controlled by adjusting the area of the first and second conductive metal layers.

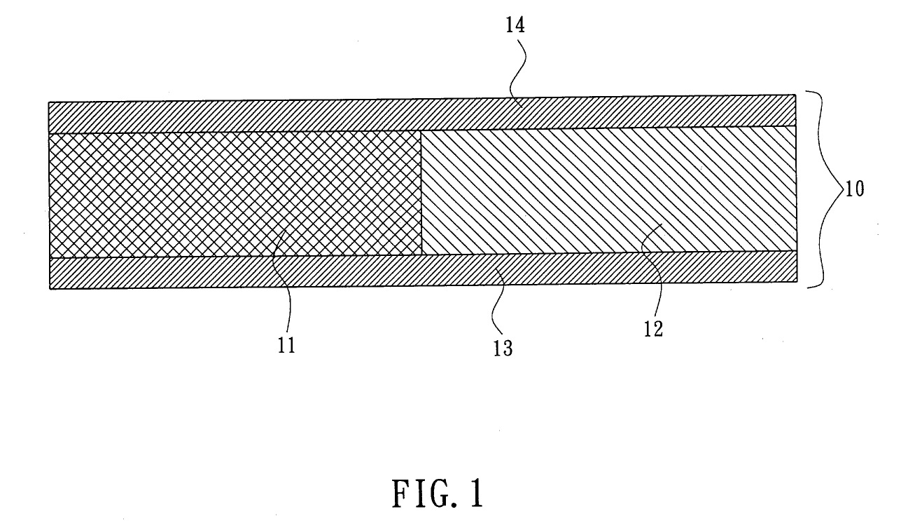

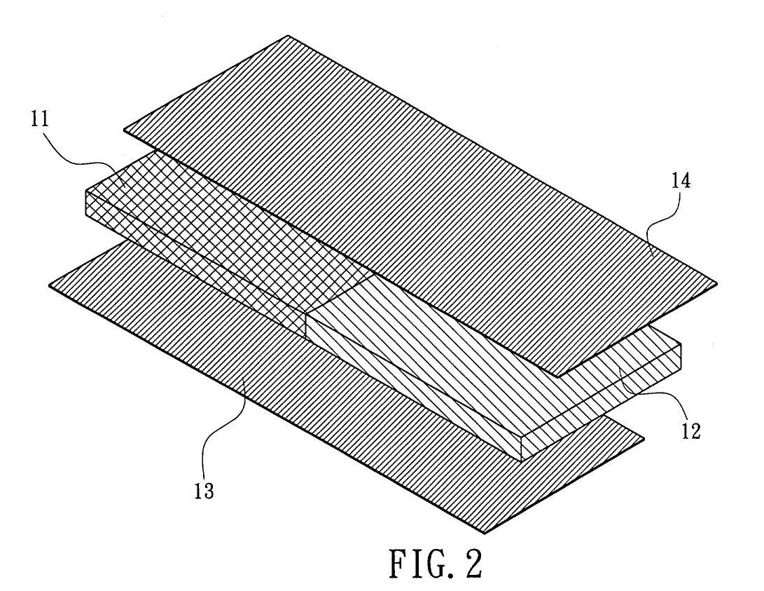

A three-layered capacitor substrate of the invention is shown in FIG. 1. The invention provides two dielectric materials with different dielectric coefficients to form a dielectric layer. It simultaneously has a dielectric material 111 with a low dielectric coefficient (∈ᵣ≦4) needed for high-speed signal transmissions and a dielectric material 12 with a high dielectric coefficient (∈ᵣ≧10) needed for decoupling capacitor that suppresses high-frequency noises. Each of the upper and lower surfaces of the dielectric layer is attached with a copper foil 13, 14 to form an interleaving striped capacitor. The capacitor substrate 10 is a copper foil 14/dielectric materials 11, 12/copper foil 13 three-layered structure, as shown in FIG. 2. The capacitor substrate 10 can be inserted into any layer in a multiple-layered print circuit board. Alternatively, several layers of the capacitor substrates are stacked on a print circuit board to form a capacitor substrate with multiple-layered interleaving striped capacitors.

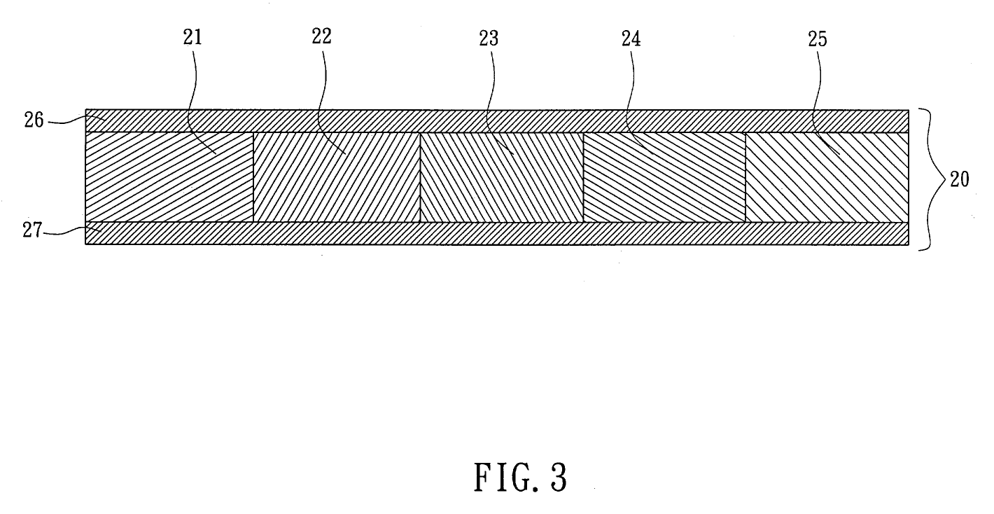

Another embodiment of the invention is demonstrated in FIG. 3, which is a single-layered interleaving striped capacitor substrate comprised of five dielectric materials. Five dielectric materials 21, 22, 23, 24, 25 with five different dielectric coefficients are utilized to provide different electronic properties. A copper foil 26, 27 is further attached onto each of the upper and lower surfaces to form a capacitor substrate 20 with embedded interleaving striped capacitors.

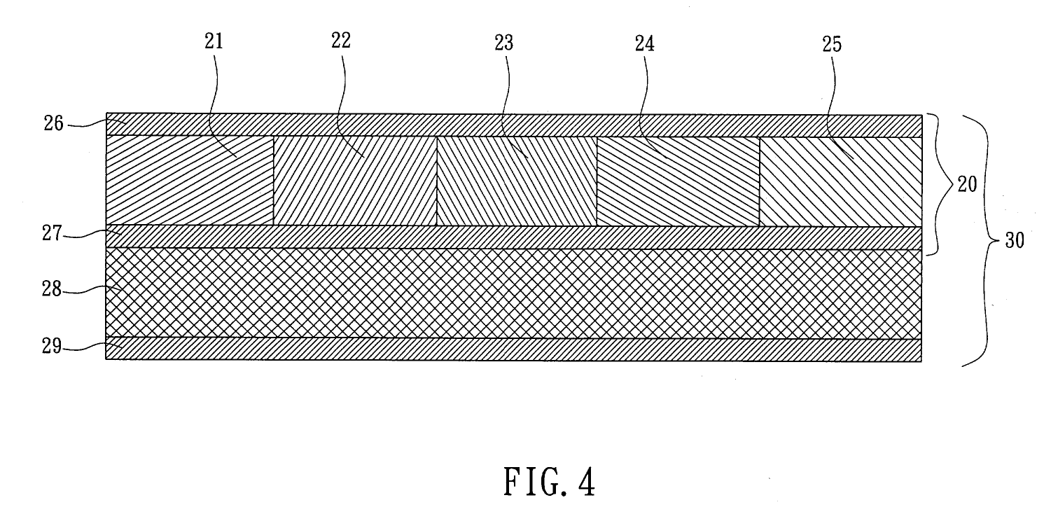

The capacitor substrate 20 with embedded interleaving striped capacitors can be inserted into any layer of a multiple-layered print circuit board. Alternatively, several such capacitor substrates are stacked on a print circuit board 28 to form a multiple-layered capacitor substrate 30, as shown in FIG. 4.

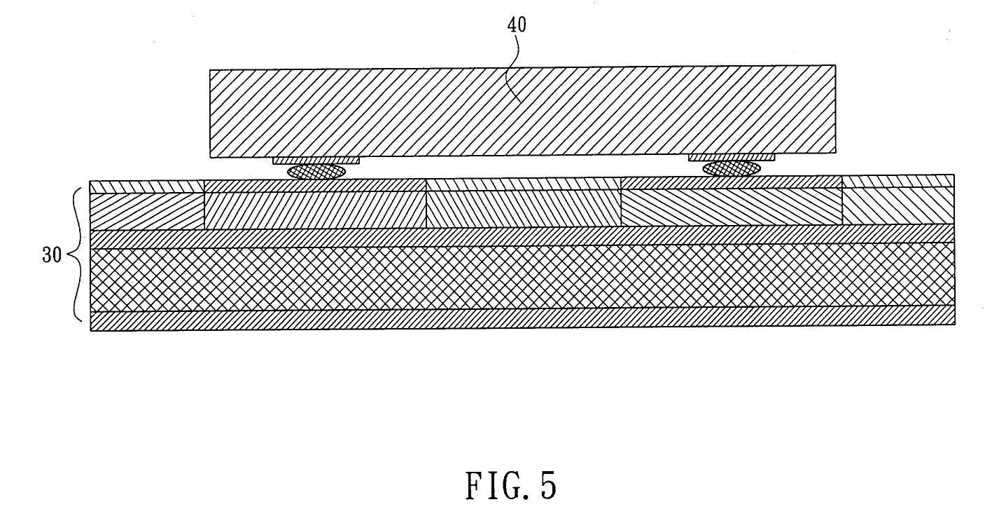

The types, arrangement, and width ratios of the interleaving striped dielectric materials can be modified according to practical needs. The copper foils on the upper and lower surfaces of the dielectric layer should also be etched into the required circuit. The conductive layers (the copper foil part) drawn in FIGS. 1 to 4 are only schematic. In practice, the dielectric layers with different dielectric coefficients are etched to form the capacitors in the circuit. The capacitance of each of the capacitors is adjusted by changing the area of the conductive layer. That is, the invention can be formed with capacitors of different dielectric coefficients using interleaving striped dielectric materials on the same substrate. This achieves the goal of having capacitors with different capacitances on a single substrate. As shown in FIG. 5, an integrated circuit (IC) 40 is combined onto a multiple-layered capacitor substrate 30 by crystallization. The multiple-layered capacitor substrate 30 is made by stacking the interleaving striped capacitor substrates on a traditional print circuit board. The differences of the dielectric coefficients in the interleaving striped capacitors can provide the IC 40 different electronic properties.

The invention is a striped substrate comprised of dielectric materials with several different dielectric coefficients. The types, depositions, and width ratios of the interleaving striped dielectric materials can be modified according to practical needs. For example, the capacitor substrate with a high dielectric coefficient (≧10) can be used as the capacitor so that a large capacitance can be achieved within the smallest area. This can be used as a decoupling capacitor for filtering high-frequency noises. On the other hand, the capacitor substrate with a low dielectric coefficient (≦4) can be used in the design of a high-speed IC transmission line (signal connection line). A low dielectric coefficient material has a smaller capacitor load effect. Consequently, the same circuit area can have more high-speed area for wiring. The electric signals on the lines can be transmitted with less time. Such elements can be applied to synchronized digital systems, such as personal computers. The design is thus made simpler, and the timing margin control is easier. For example, the bus lines from the central processing unit (CPU) to the SDRAM and the system memory bus lines from the chip set to the DRAM can have a higher efficiency owing to the decrease in the propagation delay time. The work frequency and performance of the system can be greatly enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An interleaving striped capacitor substrate structure for pressing-type print circuit boards, the structure comprising:
a dielectric layer, which consists of a plurality of interleaving striped dielectric materials;
an upper-surface conductive metal layer, which is attached on the upper surface of the dielectric layer; and
a lower-surface conductive metal layer, which is attached on the bottom surface of the dielectric layer;
wherein the upper-surface conductive metal layer and the lower-surface conductive metal layer are etched in accordance with one of the plurality of dielectric materials to produce a capacitor, and the capacitance of the capacitor is controlled by adjusting the areas of the upper-surface conductive metal layer and the lower-surface conductive metal layer.

2. The interleaving striped capacitor substrate structure of claim 1, wherein the dielectric materials include at least one high dielectric coefficient material with a dielectric coefficient between 10 and 100.

3. The interleaving striped capacitor substrate structure of claim 1, wherein the dielectric materials include at least one low dielectric coefficient material with a dielectric coefficient below 4.

4. The interleaving striped capacitor substrate structure of claim 1, wherein the upper-surface conductive metal layer and the lower-surface conductive metal layer are made of copper.

5. The interleaving striped capacitor substrate structure of claim 1, wherein the upper-surface conductive metal layer and the lower-surface conductive metal layer are formed with a desired conductive metal wire pattern in accordance with the plurality of interleaving striped dielectric materials.

6. The interleaving striped capacitor substrate structure of claim 1, wherein the upper-surface conductive metal layer and the lower-surface conductive metal layer form a plurality of capacitors with the plurality of interleaving striped dielectric materials.

7. The interleaving striped capacitor substrate structure of claim 1 combined with one selected from a single-layered print circuit board and a multiple-layered print circuit board.

8. An interleaving striped capacitor substrate structure for pressing-type print circuit boards, the structure comprising:
a dielectric layer, which consists of a plurality of interleaving striped dielectric materials;
a surface conductive metal layer, which is attached on the upper surface of the dielectric layer, is etched to form a circuit and forms a capacitor with the dielectric layer; and
a print circuit board, which has a second surface conductive metal layer;
wherein the print circuit board combines with the dielectric layer to form a multiple-layered capacitor substrate embedded with interleaving striped capacitors, the surface conductive metal layer and the second conductive metal layer are etched in accordance with one of the plurality of dielectric materials to form a capacitor, and the capacitance of the capacitor is controlled by adjusting the areas of the upper-surface conductive metal layer and the lower-surface conductive metal layer.

9. The interleaving striped capacitor substrate structure of claim 8, wherein the dielectric materials include at least one high dielectric coefficient material with a dielectric coefficient between 10 and 100.

10. The interleaving striped capacitor substrate structure of claim 8, wherein the dielectric materials include at least one low dielectric coefficient material with a dielectric coefficient below 4.

11. The interleaving striped capacitor substrate structure of claim 8, wherein the upper-surface conductive metal layer and the lower-surface conductive metal layer are made of copper.

12. The interleaving striped capacitor substrate structure of claim 8, wherein the upper-surface conductive metal layer and the lower-surface conductive metal layer are formed with a desired conductive metal wire pattern in accordance with the plurality of interleaving striped dielectric materials.

13. The interleaving striped capacitor substrate structure of claim 8, wherein the upper-surface conductive metal layer and the lower-surface conductive metal layer form a plurality of capacitors with the plurality of interleaving striped dielectric materials.

14. The interleaving striped capacitor substrate structure of claim 8 combined with one selected from a single-layered print circuit board and a multiple-layered print circuit board.
